(19) United States
(12) Patent Application Publication
(10) Pub. No.: US 2010/0116992 A1
(43) Pub. Date: May 13, 2010

(54) SCINTILLATOR PANEL AND RADIATION FLAT PANEL DETECTOR

(75) Inventors: Shinji Kudo, Tokyo (JP); Yasushi Nakano, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA MEDICAL & GRAPHIC, INC., Tokyo (JP)

(21) Appl. No.: 12/530,545

(22) PCT Filed: Feb. 22, 2008
(86) PCT No.: PCT/JP2008/053051

§ 371 Date: Sep. 9, 2009

(30) Foreign Application Priority Data
Mar. 13, 2007 (JP) 2007063229

(51) Int. Cl. G01T 1/20; C09K 11/61

(52) U.S. Cl. 250/361 R; 250/484.4

(57) ABSTRACT

There are provided a scintillator panel excellent in productivity and exhibiting enhanced emission-extracting efficiency and sharpness, resulting in reduced deterioration in sharpness between planar light-receiving element, and a radiation flat panel detector. The scintillator panel comprises a scintillator plate, wherein the scintillator plate comprises a protective layer comprising the first protective film provided on the side of the scintillator layer and the second protective film provided on the side of the substrate opposite the scintillator layer and the protective layer has a lug which is a sealed portion of the first protective film and the second protective film, and the length of the lug of the protective layer is represented by a specific expression, the first protective film is not adhered to the scintillator layer and the scintillator plate is provided as a constituent element for a radiation flat panel detector without being physicochemically adhered to the surface of a planar light receiving element.

### TECHNICAL FIELD

The present invention relates to a scintillator panel which are used in formation of a radiographic image of an object, and a radiation flat panel detector by use thereof.

### TECHNICAL BACKGROUND

There have been broadly employed radiographic images such as X-ray images for diagnosis of the conditions of patients on the wards. Specifically, radiographic images using a intensifying-screen/film system have achieved enhancement of speed and image quality over its long history and are still used on the scene of medical treatment as an imaging system having high reliability and superior cost performance in combination. However, these image data are so-called analog image data, in which free image processing or instantaneous image transfer cannot be realized.

Recently, there appeared digital system radiographic image detection apparatuses, as typified by a computed radiography (also denoted simply as CR) and a flat panel detector (also denoted simply as FPD). In these apparatuses, digital radiographic images are obtained directly and can be displayed on an image display apparatus such as a cathode tube or liquid crystal panels, which renders it unnecessary to form images on photographic film. Accordingly, digital system radiographic image detection apparatuses have resulted in reduced necessities of image formation by a silver salt photographic system and leading to drastic improvement in convenience for diagnosis in hospitals or medical clinics.

The computed radiography (CR) as one of the digital technologies for radiographic imaging has been accepted mainly at medical sites. However, image sharpness is insufficient and spatial resolution is also insufficient, which have not yet reached the image quality level of the conventional screen/film system. Further, there appeared, as a digital X-ray imaging technology, an X-ray flat panel detector (FPD) using a thin film transistor (TFT), as described in, for example, the article “Amorphous Semiconductor Usher in Digital X-ray Imaging” described in Physics Today, November, 1997, page 24 and also in the article “Development of a High Resolution, Active Matrix, Flat-Panel Imager with Enhanced Fill Factor” described in SPIE, vol. 32, page 2 (1997).

To convert radiation to visible light is employed a scintillator panel made of an X-ray phosphor which is emissive for radiation. The use of a scintillator panel exhibiting enhanced emission efficiency is necessary for enhancement of the SN ratio in radiography at a relatively low dose. Generally, the emission efficiency of a scintillator panel depends of the phosphor layer thickness and X-ray absorbance of the phosphor. A thicker phosphor layer causes more scattering of emission within the phosphor layer, leading to deteriorated sharpness. Accordingly, necessary sharpness for desired image quality level necessarily determines the layer thickness.

Specifically, cesium iodide (CsI) exhibits a relatively high conversion rate of from X-rays to visible light. Further, a columnar crystal structure of the phosphor can readily be formed through vapor deposition and its light guide effect inhibits scattering of emitted light within the crystal, enabling an increase of the phosphor layer thickness.

However, the use of CsI alone results in reduced emission efficiency. For example, JP-B 54-35060 (hereinafter, the term JP-B refers to Japanese Patent Publication) disclosed a technique for use as an X-ray phosphor in which a mixture of CsI and sodium iodide (NaI) at any mixing ratio was deposited on a substrate to form sodium-activated cesium iodide (CsI:Na), which was further subjected to annealing as a post-treatment to achieve enhanced visible-conversion efficiency.

There were also proposed other means for enhancing light output, including, for example, a technique of rendering a substrate to form a scintillator thereon reflective, as described in patent document 1; a technique of forming a reflection layer on a substrate, as described in patent document 2; and a technique of a scintillator on a transparent organic film covering a reflective thin metal film provided on a substrate, as described in patent document 3. These techniques increased the light quantity but resulted in markedly deteriorated sharpness.

Techniques for placing a scintillator panel on the surface of a flat light-receiving element include, for example, those disclosed in JP-A Nos. 5-312961 and 6-331749. However, these are poor in production efficiency and cannot avoid deterioration in sharpness on a scintillator panel and a flat light-receiving surface.

Production of scintillator plates through a gas phase method were generally conducted by forming a scintillator layer on a rigid substrate such as aluminum or amorphous carbon and covering the entire surface of the scintillator layer with a protective layer, as described in, for example, patent document 4. However, formation of a scintillator layer on a substrate which cannot be freely bent is easily affected by deformation of the substrate or curvature at the time of vapor deposition when sticking a scintillator plate on the flat light-receiving element surface with paste, leading to defects such that uniform image quality characteristics cannot be achieved with the flat light-receiving surface of a flat panel detector. Further, a metal substrate exhibits a high X-ray absorption, producing problems, specifically when performing low exposure. In contrast, amorphous carbon which has been recently employed is useful in terms of low X-ray absorptivity but is difficult to be acceptable in practical production since no general-purpose one of a large size is available and its price is high. Accordingly, such problems have become serious along with the recent trend of increasingly larger flat panel detectors.

To avoid these problems was generally performed formation of a scintillator directly on the surface of a flat light-receiving element (i.e., on an imaging device) through vapor deposition or the use of a medical intensifying screen exhibiting flexibility but low sharpness instead of a scintillator plate. There was also disclosed the use of a soft protective layer such as poly-p-xylilene, as disclosed in, for example, patent document 5.

Although a scintillator material deposited directly on a flat light-receiving element exhibits enhanced image characteristics, such a scintillator material, however, has a cost defect such that a high-priced light-receiving element is wasted in occurrence of a defective product, and a heat treatment achieves enhancement of image characteristics of the scintillator material but a light-receiving element exhibits low heat resistance and is restricted in treatment temperature. There was also the problem of it being a cumbersome procedure such that it was necessary to include cooling the light-receiving element during thermal treatment. On the contrary, an indirect type in which a scintillator material deposited on the substrate is superimposed onto a light-receiving element advantageously improves the defect of the foregoing direct-deposited scintillator material (direct type).

However, a phosphor-deposited layer, as an image forming layer of a deposition scintillator material, is a material which is fragile to moisture (humidity). Accordingly, a sealing film was used as a protective layer, which was often insufficient in moisture resistance.

Patent document 1: Japanese Patent Publication JP-B No 7-21560

Patent document 2: JP-B No. 1-240887

Patent document 3: Japanese Patent Application Publication JP-A No. 2600-356679

Patent document 4: JP-B No. 3566926

Patent document 5: JP-A No. 2002-116258

### DISCLOSURE OF THE INVENTION

### Problems to be Solved

In view of the foregoing problems, the present invention has come into being, therefore, it is an object of the present invention to provide a scintillator panel which exhibits a low deterioration rate and also low incidence of specific failures in a moisture resistance test and minimized image unevenness and linear noise, while maintaining enhanced luminance, and a radiation flat panel detector by use thereof.

### Means to Solve the Problems

The foregoing problems related to the present invention were overcome by the following constitution.

1. A scintillator panel comprising a scintillator plate comprising on a substrate a reflection layer, a subbing layer and a scintillator layer, wherein the scintillator plate comprises a protective layer comprising a first protective film provided on a side of the scintillator layer and a second protective film provided on a side of the substrate opposite the scintillator layer and the protective layer has a lug which is a portion sealed with the first protective film and the second protective film, and wherein a length of the lug of the protective layer is represented by the following expression (A-1), the first protective film is not adhered to the scintillator layer and the scintillator plate is provided as a constituent element for a radiation flat panel detector without being physicochemically adhered to a surface of a planar light receiving element,

### Expression (A-1):

provided that a layer existing between moisture-proof layers of the first protective film and the second protective film and exhibiting a highest moisture permeability has a thickness exhibiting a moisture permeability equivalent to a moisture permeability in a direction of thickness of a moisture-proof layer of the first protective film or a moisture permeability of two times the moisture permeability in a direction of thickness of a moisture-proof layer of the first protective film,

a length of the lug of the protective layer=at least a length in a direction of length of the lug, which is a difference in thickness between a layer exhibiting a moisture permeability equivalent to a moisture permeability of a moisture-proof layer of the first protective film and a layer exhibiting a moisture permeability of two times the moisture permeability of a moisture-proof layer of the first protective film.

2. The scintillator panel as claimed in claim 1, wherein the length of the lug of the protective layer is represented by the following expression (A-2),

### Expression (A-2):

provided that a layer existing between moisture-proof layers of the first protective film and the second protective film and exhibiting a highest moisture permeability has a thickness exhibiting a moisture permeability equivalent to a moisture permeability in a direction of thickness of a moisture-proof layer of the first protective film,

a length of the lug of the protective layer=at least a length in a direction of length of the lug and equivalent to a thickness of the layer exhibiting a moisture permeability equivalent to a moisture permeability of a moisture-proof layer of the first protective film.

3. The scintillator panel as claimed in claim 1 or 2, wherein the scintillator layer is a columnar phosphor layer which is comprised of cesium iodide and is formed by a process of vapor deposition.
4. The scintillator panel as claimed in any one of claims 1 to 3, wherein the substrate is a heat-resistant resin.
5. A radiation flat panel detector comprising a scintillator panel as claimed in any one of claims 1 to 4, wherein the scintillator panel is not physicochemically adhered to a surface of a planar light receiving element.

### EFFECT OF THE INVENTION

According to the foregoing means, there can be provided a scintillator panel which exhibits a low deterioration rate and also low incidence of specific failures in a moisture resistance test and minimized image unevenness and linear noise, while maintaining enhanced luminance, and a radiation flat panel detector by use thereof.

### BRIEF DESCRIPTION OF THE DRAWINGS

FIG. 1 shows a plan view of a scintillator panel.

FIG. 2 illustrate examples of the structure of a scintillator panel and the structure of a lug of a protective layer.

FIG. 3 shows a sectional view along line A-A′ of FIG. 1(a).

FIG. 4 illustrates light refraction in the void portion illustrated in FIG. 3 and also illustrates light refraction in the state of a conventional protective film being in contact with a scintillator layer (phosphor layer).

FIG. 5 illustrates a vapor deposition apparatus to form a scintillator layer on a substrate by the process of vapor deposition.

### DESCRIPTION OF THE ALPHANUMERIC DESIGNATIONS

1a-1c: Scintillator panel
101: Scintillator panel
101a, 3: Substrate
101b: Scintillator layer (phosphor layer)
101c: Reflection layer
101d: Resin subbing layer
102a, 104: First protective film
102b: Second protective film
103a-103d, 105a, 105b, 107a-107c: Sealing portion
108: Void portion (air layer)
E-H: Point contact portion
R T, X-Z: Light
2: Vapor deposition apparatus
201: Vacuum vessel
202: Evaporation source
203: Substrate holder
204: Substrate rotation mechanism
205: Vacuum pump

### Preferred Embodiments of the Invention

A scintillator panel of the present invention is a scintillator panel employing a scintillator plate is featured in that the scintillator plate comprises a substrate having thereon a reflection layer, a subbing layer and a scintillator layer, wherein the scintillator plate comprises a protective layer comprising a first protective film arranged on the side of the scintillator layer and a second protective film arranged on the side of the substrate opposite the scintillator layer, the protective layer includes a lug which is a sealed portion of the first protective film and the second protective film, and wherein a length of the lug of the protective layer is indicated by the following expression (A-1), the first protective film is not adhered to the scintillator layer and the scintillator plate is provided as a constituent element for a radiation flat panel detector while not being physicochemically adhered to the surface of a planar light receiving element,

### Expression (A-1):

provided that a layer existing between moisture-proof layers of the first protective film and the second protective film and exhibiting a highest moisture permeability has a thickness exhibiting a moisture permeability equivalent to a moisture permeability in a direction of thickness of a moisture-proof layer of the first protective film or a moisture permeability of two times the moisture permeability in a direction of thickness of a moisture-proof layer of the first protective film,

a length of the lug of the protective layer=at least a length in a direction of length of the lug, which is a difference in thickness between a layer exhibiting a moisture permeability equivalent to a moisture permeability of a moisture-proof layer of the first protective film and a layer exhibiting a moisture permeability of two times the moisture permeability of a moisture-proof layer of the first protective film.

The foregoing feature is a common technical feature in the present invention as claimed in claims 1-5.

There will be described constituent features of the present invention.

### Constitution of Scintillator Plate and Panel

The scintillator plate of the present invention comprises a reflection layer, a subbing layer and a scintillator layer provided sequentially in this order on a substrate. Further, a scintillator panel relating to the present invention is comprised of a scintillator plate provided with a protective layer. In the present invention, the scintillator plate comprises a protective layer comprising a first protective film disposed on the scintillator layer side and a second protective film disposed on the outside of the substrate and the protective layer has a lug, as a sealing portion formed of the first protective film and the second protective film.

### Scintillator Layer

A material to form a scintillator layer (also denoted as a phosphor layer) may employ a variety of commonly known phosphor materials, of which cesium iodide (CsI) is preferred since it exhibits an enhanced conversion rate of X-rays to visible light and readily forms a columnar crystal structure of a phosphor, whereby scattering of emitted light within the crystal is inhibited through the light guide effect, rendering it feasible to increase the scintillator layer thickness.

CsI exhibits by itself a relatively low emission efficiency so that various activators are incorporated. For example, JP-B No. 54-35060 disclosed a mixture of CsI and sodium iodide (NaI) at any mixing ratio. Further, JP-A No. 2001-59899 disclosed vapor deposition of CsI containing an activator, such as thallium (Tl), europium (Eu), indium (In), lithium (Ii), potassium (K), rubidium (Ru) or sodium (Na). In the present invention, thallium (Tl) or europium (Eu) is preferred, of which thallium (Tl) is more preferred.

In the present invention, it is preferred to employ, as raw materials, an additive containing at least one thallium compound and cesium iodide. Thus, thallium-activated cesium iodide (denoted as CsI:Tl), which exhibits a broad emission wavelength of from 400 to 750 nm, is preferred.

There can be employed various thallium compounds (compound having an oxidation number of +I or +III) as a thallium compound contained in such an additive.

Preferred examples of thallium compounds include thallium bromide (TlBr), thallium chloride (TlCl), and thallium fluoride (TlF).

The melting point of a thallium compound relating to the present invention is preferably in the range of 400 to 700° C. A melting point more than 700° C. results in inhomogeneous inclusions of an additive within the columnar crystal. In the present invention, the melting point is one under ordinary temperature and ordinary pressure.

The molecular weight of a thallium compound is preferably in the range of from 206 to 300.

In the scintillator layer of the present invention, the content of an additive, as described above is desirably optimized in accordance with its object or performance but is preferably from 0.001 to 50.0 mol % of cesium iodide, and more preferably from 0.1 to 10.0 mol %.

An additive content of less than 0.001 mol % of cesium iodide results in an emission luminance which is almost identical level to the emission luminance obtained by cesium iodide alone. An additive content of more than 50 mol % makes it difficult to maintain the properties or functions of cesium iodide.

In the present invention, after forming a scintillator layer by vapor-deposition of scintillator materials on a polymer film, it is necessary to subject the formed scintillator layer to a thermal treatment in an atmosphere within a temperature range of from −50° C. to +20° C., based on the glass transition temperature of the polymer film over a period of 1 hr or more. Thereby, neither deformation of the film nor flaking of the phosphor occurs, whereby a scintillator panel of high emission efficiency can be realized.

As can be seen from the foregoing description, the scintillator layer related to the invention is preferably a columnar phosphor layer containing cesium iodide, which is formed preferably by a gas phase process.

### Reflection Layer

A reflection layer relating to the present invention reflects light emitted from a scintillator to enhance a light extraction efficiency. The reflection layer is preferably formed of a material containing at least one element selected from Al, Ag, Cr, Cu, Ni, Ti, Mg, Rh, Pt, and Au. It is specifically preferred to use a metal thin-film formed of the foregoing elements, for example, Ag film and Al film. It is also preferred to fo/m two or more metal thin-films.

### Subbing Layer

A subbing layer is needed to be provided between the reflection layer, and the scintillator layer to protect the reflection layer.

Such a subbing layer preferably contains a polymeric binding material (or binder), a dispersing agent and the like.

The subbing layer thickness is preferably from 0.5 to 2 μm. A subbing layer thickness of not less than 3 μm results in increased light scattering within the subbing layer, leading to deteriorated sharpness. A subbing layer thickness of not more than 2 μm does not give rise to disorder of columnar crystallinity, even when subjected to a thermal treatment.

In the following, there will be described constituting elements of a subbing layer.

### Polymer Binding Material

A subbing layer related to the present invention is formed preferably by coating a polymer binding material (hereinafter, also denoted simply as a binder) dissolved or dispersed in a solvent, followed by drying. Specific examples of a polymer binding material include a polyimide or a polyimide-containing, a polyurethane, a vinyl chloride copolymer, a vinyl chloride/vinyl acetate copolymer, a vinyl chloride/vinylidene chloride copolymer, a vinyl chloride/acrylonitrile copolymer, butadiene/acrylonitrile copolymer, a polyamide resin, polyvinyl butyral, a polyester, a cellulose derivative (e.g., nitrocellulose), a styrene-butadiene copolymer, various kinds of synthetic rubbers, a phenol resin, an epoxy resin, a urea resin, a melamine resin, a phenoxy resin, a silicone resin, an acryl resin and a urea-formamide resin. Of these, a polyurethane, a polyester, a vinyl chloride copolymer, a polyvinyl butyral and a nitrocellulose are preferred.

A polyimide or a polyimide-containing resin, a polyurethane, a polyester, a vinyl chloride copolymer, a polyvinyl butyral, and a nitrocellulose are preferred as a polymer binder relating to the present invention, specifically in teems of adhesion to the scintillator layer. A polymer having a glass transition temperature (Tg) of 30 to 100° C. is also preferred in terms of adhesion of the deposited crystals to the substrate. In view of these, a polyester resin is specifically preferred. However, there are some cases in which a polymer having a Tg of 30 to 100° C. is difficult to ensure sufficient heat resistance when increasing a thermal treatment temperature to achieve enhancement of image characteristics such as luminance.

Specific examples of a solvent used for preparation of a subbing layer include N,N-dimethylacetoamide, N-methyl-2-pyrrolidone, a lower alcohol such as methanol, ethanol, n-propanol or n-butanol, a chlorine-containing hydrocarbon such as methylene chloride or ethylene chloride, a ketone such as acetone, methyl ethyl ketone or methyl isobutyl ketone; an aromatic compound such as toluene or benzene or xylene, cyclohexane, cyclohexanone; an ester of a lower carboxylic acid and a lower alcohol such as methyl acetate, ethyl acetate or butyl acetate; dioxane, an ether such as ethylene glycol monoethyl ether or ethylene glycol monomethyl ether; and their mixtures.

The subbing layer related to the present invention may contain a pigment or a dye to prevent scattering of light emitted from the scintillator to achieve enhanced sharpness.

### Protective Layer

A protective layer relating to the present invention is mainly intended to protect the scintillator layer. Specifically, since highly hygroscopic cesium iodide (CsI) easily absorbs moisture upon exposure to air, resulting in deliquescence, prevention thereof is the main aim of providing a protective layer. Such a protective layer can be formed using various materials.

In a scintillator panel relating to the present invention, a protective layer can be provided on the scintillator layer of the scintillator panel.

Further, one preferred embodiment of the present invention is that the scintillator panel is sealed with a first protective film disposed on the Side of the foregoing scintillator layer on one side of the substrate and a second protective layer disposed on the outside (or the other side) of the substrate, and the first protective film is not physicochemically adhered to the scintillator layer.

Herein, the expression “is not physicochemically adhered” means not being bonded via a physical interaction or a chemical reaction by use of an adhesive agent, as afore-mentioned. Such a state of not being adhered may also refer to a state in which the surface of the scintillator layer and the protective film are optically or mechanically treated almost as a non-continuous body even if the scintillator surface is in point-contact with the protective film.

There will be detailed a protective film used in the present invention.

### Protective Film

Constitution of a protective film used in the present invention include, for example, a multi-layered material having a constitution of outermost layer (protection-functioning layer)/intermediate layer (moisture-proof layer)/innermost layer (heat fusible layer). The individual layer may be multi-layered if needed.

### Innermost Layer (Heat Fusible Layer)

A thermoplastic resin film as an innermost layer preferably employs EVA, PP, LOPE, LLDPE, LDPE produced by use of a metallocene catalyst, LLDPE and films obtained by mixed use of these films and HOPE film.

Intermediate layer (Moisture-Proof Layer)

Examples of an intermediate layer (moisture-proof layer) include a layer having an inorganic film, as described in JP-A No. 6-95302 and “Shinku (Vacuum) Handbook” Revised Edition, pp 132-134 (ULVC Nippon Shinku Gijutsu K.K.). Such an inorganic film includes, for example, a vapor-deposited metal film and a vapor-deposited inorganic material film.

Vapor-deposited metal films include, for example, ZrN, SiC, TiC, Si₃N₄, single crystal Si, ZrN, PSG, amorphous Si, W, and aluminum, and specifically preferred metal vapor-deposited film is aluminum.

Vapor-deposited inorganic material films include, for example, those described in “Hakumaku (Thin Film) Handbook” pp 879-901 (edited by Nippon Gakujutsu Shinkokai); and “Shinku (Vacuum) Handbook” Revised Edition, pp 132-134 (ULVC Nippon Shinku Gijutsu K.K.). Examples of inorganic material film include Cr₂O₃, SiₓO_{y} (x=1, y=1.5-2.0), Ta₂O₃, ZrN, SiC, TiC, PSG, Si₃N₄, single crystal Si, amorphous Si, W, and Al₂O₃.

Resin film used as a base material of an intermediate layer (moisture-proof layer) may employ film materials used for packaging film of ethylene tetrafluoroethylene copolymer ETFE), high density polyethylene (HDPE), oriented polypropylene (OPP), polystyrene (PS), polymethyl methacrylate (PMMA), biaxially oriented nylon 6, polyethylene terephthalate (PET), polycarbonate (PC), polyimide, polyether styrene (PES) and the like.

Vapor-deposit film can be prepared by commonly known methods, as described in “Shinku (Vacuum) Handbook” and Hoso Gijutsu, Vol. 29, No. 8, for example, a resistance heating or high-frequency induction heating method, an electron beam (EB) method, and plasma (PCVD). The thickness of deposit film is preferably from 20 to 400 nm, and more preferably from 50 to 180 nm.

### Outermost Layer (Protection-Functioning Layer

Resin film used over deposited film may employ polymer films used as packaging film of low density polyethylene (LDPE), HDPE, linear low density polyethylene (LLDPE), medium density polyethylene, casting polypropylene (CPP), OPP, oriented nylon (ONy), PET, cellophane, polyvinyl alcohol (PVA), oriented vinylon (OV), ethylene-vinyl acetate copolymer (EVOH), poltvinylidene chloride (PVDC), and a polymer of a fluorinated olefin (fluoroolefin) or a copolymer of fluorinated olefins.

Such resin film may optionally employ a multi-layer film made by co-extrusion of different kinds of films or a multi-layer film made by lamination with varying the orientation angle. Further, there may be combined film density, molecular weight distribution and the like to achieve physical properties needed for a packaging material. A thermoplastic resin film of the innermost layer employs LDPE, LLDPE, LDPE made by use of a metallocene catalyst, LLDPE, and a film made by mixed use of these films and HDPE film.

In the case of using no inorganic material-deposited film, a protective layer is required to function as an intermediate layer. In that case, single or plural thermoplastic films used for the protective layer may be superimposed. There may be employed, for example, CPP/OPP, PET/OPP/LDRE, Ny/OPP/LDPE, CPP/OPP/EVOH, Saran UB/LLDPE (in which Saran UB is biaxially oriented film made from vinylidene chloride/acrylic acid ester copolymer resin, produced by Asahi Kasei Kogyo Co., Ltd.), K-OP/PP, K-PET/LLDPE, K-Ny/EVA (in which “K” denotes a a vinylidene chloride resin-coated film).

These protective films can be prepared by commonly known methods, for example, a wet lamination method, a dry lamination method, a hot melt lamination method, an extrusion lamination method, and a heat lamination method. When using no inorganic material-deposited film, these methods are applicable. Further, there are also applicable a multi-layer inflation system and co-extrusion molding system, depending on the materials to be used.

There are usable commonly known adhesives for lamination. Examples of such adhesives include heat-soluble thermoplastic polyolefin resin adhesives such as various kinds of polyethylene resins and polypropylene resins; heat-meltable thermoplastic resin adhesives such as ethylene copolymer resin (e.g., ethylene-propylene copolymer, ethylene-vinyl acetate copolymer, ethylene-ethyl acrylate copolymer), ethylene-acrylic acid copolymer resin and ionomer resin; and heat-meltable rubber adhesives. Examples of an emulsion or latex adhesive include emulsions of a polyvinyl acetate resin, a vinyl acetate-ethylene copolymer resin, a vinyl acetate-acrylic acid ester copolymer resin, a vinyl acetate-maleic acid ester copolymer, an acrylic acid copolymer and ethylene-acrylic acid copolymer. Typical examples of a latex type adhesive include natural rubber, styrene butadiene rubber (SBR), acrylonitrile butadiene rubber (NBR) and chloroprene rubber (CR). Adhesives used for dry lamination include an isocyanate adhesive, a urethane adhesive and polyester adhesive. There are also usable a hot melt lamination adhesive obtained by blending paraffin wax, microcrystalline wax, an ethylene-vinyl acetate copolymer resin and an ethylene-ethyl acrylate copolymer resin; a pressure-sensitive adhesive and heat-sensitive adhesive. Specific examples of a polyolefin resin adhesive used for extrusion lamination include a copolymer of ethylene and other monomers (α-olefin) such as L-LDPE resin, an ionomer resin (ionic copolymer resin) Serlin (produced by Du Pont Co.) and high Milan (produced by Mitsui Kagaku Co., Ltd.) as well as polymeric materials composed of a polyolefin resin such as polyethylene resin, polypropylene resin or polybutylene resin, and an ethylene copolymer resin (e.g., EVA, EEA). Recently, there was also used a UV-curable adhesive. Specifically, an LDPE resin and an L-LDPE resin are low in price and exhibit superior lamination altitude. A mixed resin obtained by mixing at least two of the foregoing resins to compensate drawbacks of the individual resin is specifically preferred. For instance, blending L-LDPE resin and LDPE resin results in enhanced wettability and reduced neck-in, leading to an enhanced laminating speed and reduced pin-holes.

Taking into account protective property, image sharpness, moisture-proof and workability of a scintillator layer (phosphor layer), the thickness of a protective film is preferably not less than 12 and not more than 200 μm and regarding the first protective layer provided on the side of a scintillator layer, which greatly affects image quality, its thickness is preferably not less than 50 μm and not more than 150 μm. Further, taking into account image sharpness, radiation image uniformity, production stability and workability, the haze ratio is preferably not less than 3% and not more than 40%, and more preferably not less than 3% and not more than 10%. The haze ratio represents a value measured, for example, by NDH 5000W of Nippon Denshoku Kogyo Co., Ltd. A targeted haze ratio can be achieved by making a choice from commercially available polymer films.

### Substrate

The substrate related to the invention can employ substrates of various kinds of metals, carbon, α-carbon or a heat-resistant resin, but a heat-resistant resin substrate is specifically suitable in terms of image characteristics and chemical resistance.

Such a heat-resistant resin substrate may employ commonly known resins but an engineering plastic is preferably employed. An engineering plastic refers to a highly functional plastic for industrial use (engineering use), which generally exhibits advantages such that it is high in strength and heat resistance, and superior in chemical resistance.

Engineering plastics relating to the present invention are not specifically limited, and including, for example, a polysulfone resin, a polyethersulfone resin, a polyimide resin, polyetherimide resin, a polyimide resin, a polyacetal resin, a polycarbonate resin, a polyethylene terephthalate resin, an aromatic polyester resin, a modified polyphenylene oxide resin, a polyphenylenesulfide resin, and a polyether ketone resin. These engineering plastics may be used singly or in combinations of two or more.

Further, depending of a hardening temperature is preferred the use of a super engineering plastic, as typified by a polyether ether ketone (PEEK) or polytetrafluoroethylene (PTFE).

In the present invention, it is also preferred to form a substrate with a polyimide such as a polyimide resin or a polyetherimide resin which is superior in heat resistance, machinability, mechanical strength and cost.

In view of the fact that adhering a scintillator panel onto the surface of a flat light-receiving element is affected by deformation of a substrate or its warping during vapor deposition, whereby a uniform image quality characteristic cannot be achieved within the light-receiving surface of a flat panel detector, the use of a substrate having a thickness of not less than 50 μm and not more than 500 μm renders it feasible to transform the scintillator panel to the form fitted to the shape of the flat light-receiving element surface, whereby uniform sharpness is achieved over all the light-receiving surface of the flat panel detector.

### Production of Scintillator Plate and Panel

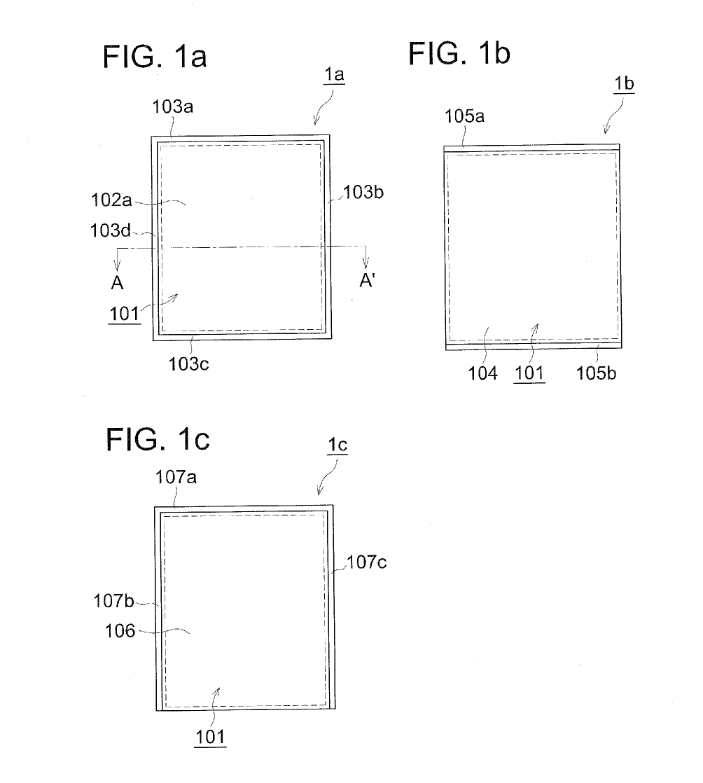

There will be further described the embodiments of the present invention with reference to FIGS. 1 to 5, but the present invention is by no means limited.

FIG. 1 illustrates a flat view of a scintillator panel. FTG. 1(a) illustrates a flat view of a scintillator panel which is sealed with a protective film by four sealed edges. FIG. 1(b) illustrates a flat view of a scintillator panel. FIG. 1(c) illustrates a flat view of a scintillator panel which is sealed with a protective film by three sealed edges.

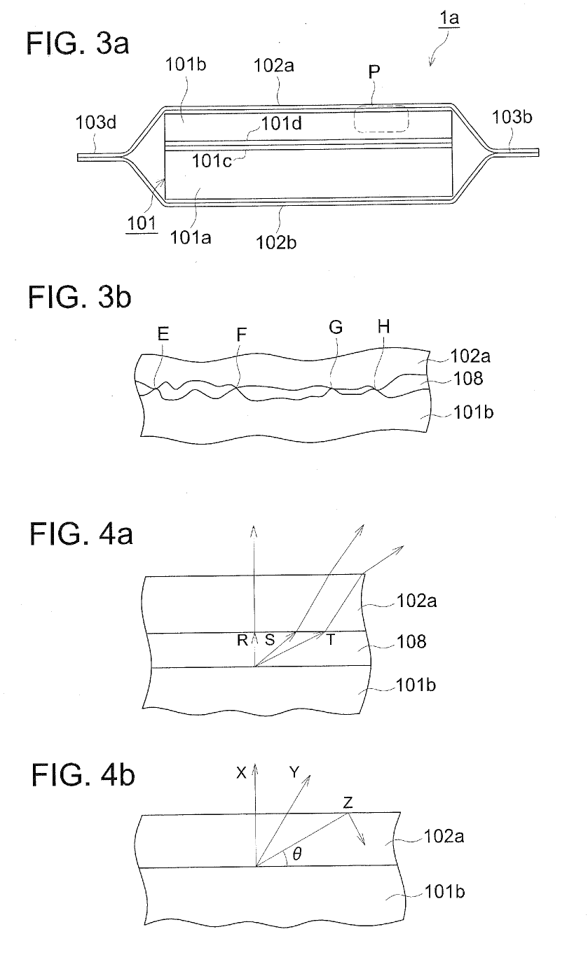

First, there will be described a scintillator panel of FIG. 1(a). In FIG. 1(a), numeral 1a designates a scintillator panel. The scintillator panel 1a is provided with a scintillator plate 101, a first protective film 102a disposed on the side of a scintillator layer 101b (FIG. 3) of the scintillator plate 101 and a second protective film 102b (FIG. 3) disposed on the side of a substrate 101a of the scintillator plate 101. 103a-103d designate four sealing sections of the first protective film 102a to the second protective film 102b (see, FIG. 3) and the sealing sections 103a-103d are each formed on the outside of the circumference of the scintillator plate 101. The four sealed edges refer to the state of having sealing portions on the four edge sections. As illustrated in this figure, the form of four sealed edges can be made by sandwiching a scintillator plate between two sheets of planar protective film and sealing four edges. In that case, this first protective film 102a and the second protective film 102b (see, FIG. 3) may be different or identical and can be optimally chosen depending on needs.

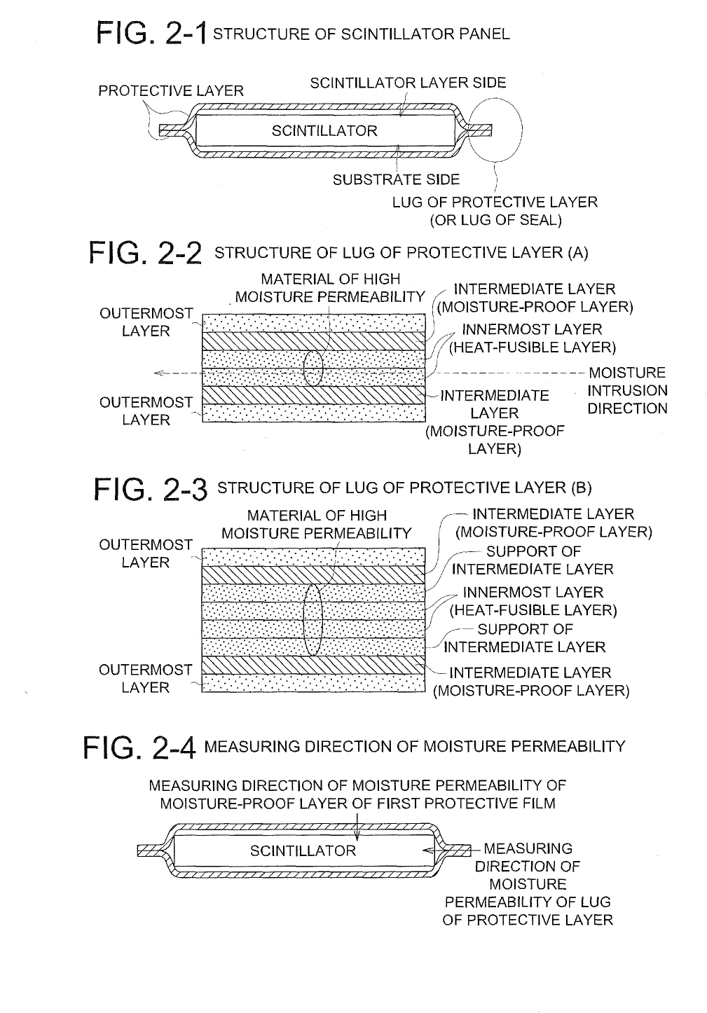

There will be described a scintillator panel of FIG. 1(b). In this figure, numeral 1b designates a scintillator panel. The scintillator panel 1b is provided with the scintillator plate 101, a first protective film 104 disposed on the side of the scintillator layer 101b (FIG. 2) of the scintillator plate 101 and a second protective film (not shown in the figure) disposed on the side of the substrate 101a of the scintillator plate 101. Numerals 105a and 105b designate two sealing portions between the first protective film 104 and the second protective film (not shown in the figure) and the sealing portions 105a and 105b are each formed on the outside of the periphery of the scintillator plate 101. The two sealed edges refer to the state having sealing portions on two edge sections. As illustrated in the figure, the two edge seal can be formed by sandwiching a scintillator plate between cylindrical protective films formed by the inflation method and sealing the two edges. In that case, a protective film used for the first protective film 104 and one used for the second protective film (not shown in the figure) are identical.

There will be described a scintillator panel of FIG. 1(c). In this figure, numeral 1c designates a scintillator panel. The scintillator panel 1c is provided with the scintillator plate 101, a first protective film 106 disposed on the side of the scintillator layer 101b (FIG. 2) of the scintillator plate 101 and a second protective film (not shown in the figure) disposed on the side of the substrate 101a of the scintillator plate 101. Numerals 107a-105c designate three sealing portions between the first protective film 104 and the second protective film (not shown in the figure) and the sealed portions 107a-107b are each formed on the outside of the periphery of the scintillator plate 101. The three sealed edges refer to the state of having sealing portions on three edge sections. As illustrated in the figure, the two edge seal can be formed by folding a sheet of protective film in the middle, sandwiching a scintillator plate between the thus formed two protective film sheets and sealing three edges. In that case, protective films used for the first protective film 106 and the second protective film (not shown in the figure) are identical. As shown in FIGS. 1(a)-1(c), the sealing portion between two sheets of the first protective film and the second protective film is outside the periphery of the scintillator plate, which renders it feasible to inhibit entrance of moisture from the outer periphery. The scintillator layer of a scintillator plate, as illustrated in FIGS. 1(a)-1(c) is formed on a substrate preferably by gas phase deposition. The process of gas phase (vapor) deposition can be performed by a vacuum deposition method, sputtering method, a CVD method, an ion plating method and the like.

The form of scintillator panels, as shown in FIGS. 1(a) to 1(c) can be chosen depending on the kind of a scintillator layer of a scintillator plate and a manufacturing apparatus.

FIG. 2 illustrates examples of the structure of a scintillator panel and the structure of a lug of a protective layer. In the present invention, the expression “sealing of protective films” refers to thermally sealing (thermal welding) heat-fusible layers which are innermost layers of the protective layer, and the thus sealed portion (seal portion) is called a lug (lug of a seal) of the protective layer. Moisture-resistance (water vapor barrier) of a protective layer depends on that of the intermediate layer (moisture-proof layer), which exhibits a higher moisture-resistance (water vapor barrier) by from single-digit to triplet-digit than an innermost layer (heat-fusible layer) or a support of the intermediate layer. Consequently, when a length of the lug of a seal is short, it is thought that such a portion gives rise to a factor to cause deterioration of the scintillator layer due to intrusion of moisture. Accordingly, it is apparent that the length of the lug of a protective layer is significantly important for moisture resistance performance of the protective layer.

Moisture permeability is one of the typical measures for moisture-resistance (moisture barrier). The moisture permeability (or water vapor transmission rate) is defined in JIS Z 0208 and expressed as unit of g/(m²·24 h). The unit does not include a dimension of layer thickness, therefore, when treating the moisture permeability of a material, for example, a resin film composed of a single composition as a simple substance, the moisture permeability (or a relative water vapor transmission rate) is not defined, unless a layer thickness is specified.

On the contrary, in the case of a composite material constituted of plural layers, such as a commercially available barrier film material, its thickness is not a matter of concern. Generally, it may be considered that the moisture permeability (water vapor transmission rate) of such a barrier film material depends on a moisture-proof layer of the highest moisture-resistance (moisture barrier). Namely, the moisture permeability of a moisture-resistant layer may be considered to be that of the moisture-proof layer. This is because the moisture permeability of the moisture-proof layer is usually lower by 1-3 digits than other layers (alternatively, moisture resistance is higher by from single to triple digits than other layers).

As described above, in cases when being sealed, the lug portion of a protective film controls deterioration of the scintillator layer, caused by intrusion of water vapor, and desirably has a length, as defined by the expression (A-2) described below. In practice, the lug portion of a protective film, which does not contribute to image formation, is also required to be as short as possible, for practice. Further, a thickness (At) of a thermal welding layer in the structure (A) of lug of protective layer, and a total thickness (Bt) of the thermal welding layer and a support of an intermediate layer in the structure (B) of the lug of the protective layer are each small at the order of μm. Accordingly, the proportion of At or Bt of the cross-section of the lug usually accounts for about 1% of the area of the protective layer films. Specifically, when sealing a 10×10 cm protective film and the thickness (At) of the thermally welded layer in the structure (A) of lug of protective layer being 20 μm (=0.02 cm), the total area of the protective film surface is 100×2 (top and bottom surfaces) and in the case of four-side sealing, the total area of the lug of a thermal welding layer of the protective layer is 10×0.02×2 (top and bottom faces)×4(four sides)=1.6 cm² and accordingly, (1.6/200)×100%=0.8% (approximately 1%). Accordingly, the expression (A-1) is formulated from the view-point of the lug of a protective layer being shortened in practice and contribution of area.

### Expression (A-1):

Provided that a layer existing between moisture-proof layers of the first protective film and the second protective film and exhibiting a highest moisture permeability has a thickness exhibiting a moisture permeability equivalent to a moisture permeability in a direction of thickness of a moisture-proof layer of the first protective film or a moisture permeability of two times the moisture permeability in a direction of thickness of a moisture-proof layer of the first protective film,

length of the lug of the protective layer=not less than a length in a direction of length of the lug, which is a difference in thickness between a layer exhibiting a moisture permeability equivalent to a moisture permeability of a moisture-proof layer of the first protective film and a layer exhibiting a moisture permeability of two times the moisture permeability of a moisture-proof layer of the first protective film;

### Expression (A-2);

Provided that a layer existing between moisture-proof layers of the first protective film and the second protective film and exhibiting a highest moisture permeability has a thickness exhibiting a moisture permeability equivalent to a moisture permeability in a direction of thickness of a moisture-proof layer of the first protective film,

length of the lug of the protective layer=not less than a length in a direction of length of the lug and equivalent to a thickness of the layer exhibiting a moisture permeability equivalent to a moisture permeability of a moisture-proof layer of the first protective film.

In fact, it is difficult to experimentally measure the moisture permeability in the direction of the length of a lug of a protective layer, which can be determined based on the measurement result of a layer exhibiting the lowest moisture permeability and having a certain thickness. Specifically, when the moisture permeability of a 1 μm thick layer is 300 g/(m²·24 h), the moisture permeability of a 1000 μm (=1 mm) thick layer is to be 0.3 g/(m²·24 h).

FIG. 3 illustrate the section along A-A′ of FIG. 1(a) and the contact state with a planar light-receiving element. FIG. 3(a) illustrates an enlarged view of the section along A-A′ of FIG. 1(a) and the state of being in contact with a planar light-receiving element. FIG. 2(b) illustrates an enlarge view of the portion designated by P in FIG. 1(a).

The scintillator plate 101 is provided with a substrate 101a and a scintillator layer formed on the substrate 101a. Numeral 102b designates a second protective film disposed on the side of a substrate 101a of the scintillator plate 101. Numeral 108 designates an air gap (air space) formed between point-contact portions E-H in which the first protective film 102a and the scintillator layer 101b are in partial contact with each other. The air gap (air space) 108 forms air space and the relationship between a refractive index of the air gap (air space) 108 and that of the first protective film 102a is:

refractive index of first protective film 102a>>refractive index of air gap (air space) 108.

Numeral 109 designates an air gap (air space) formed between point-contact portions J-O in which the first protective film 102a and a planar light-receiving element 201 are partially in contact with each other. The air gap (air space) 109 forms air space and the relationship between a refractive index of the air gap (air space) 109 and that of the first protective film 102a is:

refractive index of first protective film 102a>>refractive index of air gap (air space) 109.

Even in the case of scintillator panels illustrated in FIG. 1(b) and FIG. 1(c), the relationship between the refractive index of the air gap (air space) 108 or 109 and that of the first protective film 102a is the same as the case of the figure.

Thus, the first protective film 102a disposed on the side of the scintillator layer 101b is not in total contact with the scintillator layer 101b but is in partial contact at portions E to H. When covering the total surface of the scintillator layer 101b with the first protective film 102a disposed on the side of the scintillator layer 101b, the number of the point-contact portions E to H is preferably from not less than 0.1 portion/mm² and not more than 25 portion/mm² per surface area of the scintillator layer 101b. In the present invention, such a state means one in which the first protective film disposed on the side of the scintillator layer is substantially not in contact. In the case of a scintillator panel as shown in FIGS. 1(b) and 1(c), the relationship of the number of point-contact portions with the surface area of a scintillator layer is the same as shown in the figure.

The first protective film 102a is not in total contact with the surface of a planar light-receiving element 201 but only in partial contact at point-contact portions J-O. The number of point-contact portions J-O is preferably from not less than 0.1 portion/mm² and not more than 25 portion/mm² of the surface area of the planar light-receiving element 201.

The number of point-contact portions of the first protective film 102A with the scintillator layer 101b and the number of point-contact portions of the first protective film 102a with the planar light-receiving element 201 being each more than 25 portion/mm² is one of the causes of deteriorated sharpness. The number of point-contact portions of less than 0.1 portion/mm² results in one of causes of deteriorated luminance and image sharpness.

Measurement of the number of point-contact portions can be conducted in the manner described below.

A scintillator panel is exposed to X-rays and the emitted light is read by a planar light-receiving element using a CMOS or a CCD to obtain data of signal values. The obtained data are subjected to Fourier transform to obtain power spectrum data every spatial frequency. The number of point-contact portions can then be known from peak positions of the power spectrum. Thus, a contact point portion of the protective layer and a non-contact portion cause minute differences in luminance and the number of point-contact portions can be determined by measurement of its cycle.

However, this method detects the total sum of the number of point-contact portions of the first protective layer 102a and the scintillator layer 101b and the number of point-contact portions of the first protective film 102a and the planar light-receiving element 201. To separate the number of individual point-contacts, for example, there may be applied a technique in which the first protective film 102a and the scintillator layer 101b are totally adhered by an adhesive to determine only the number of contact points of the first protective film 102a with the planar light-receiving element 201.

As shown in the figures, in the scintillator panel 1a, the scintillator plate 101 is covered with the first protective film 102a disposed on the side of the scintillator layer 101b of the scintillator plate 101 and the second protective film 102b is disposed on the side of the substrate 101a in such a manner that the total surface of the scintillator layer 101b is substantially not adhered, and the respective end portions of four edges of the first protective film 102a and the second protective film 102b are sealed.

Methods for coverage in such a form that the entire surface of the scintillator layer 101b is covered without being substantially adhered include the following ones.

(1) The surface roughness of the surface first protective film in contact with a scintillator layer is made to be from 0.05 μm to 0.8 μm in terms of Ra, taking into account close contact with the first protective film, sharpness and close contact of the planar light-receiving element. The surface form of the first protective film can be readily controlled by selecting the resin film to be used or by coating a film containing an inorganic material onto the resin film surface. The surface roughness (Ra) refers to a value measured by SURFCOM 1400D, produced by Tokyo Seimitsu Co., ltd.

(2) Sealing of a scintillator plate with the first, protective film and the second protective film is conducted under a reduced pressure condition of 5 Pa to 8000 Pa, in which sealing in a high vacuum side results in an increased number of contact points between the protective film and the scintillator layer and sealing in a low vacuum side results in the decreased number of contact points. Further, a pressure of more than 8000 Pa, which tends to cause wrinkling on the protective film surface, is not practical.

Application of the foregoing methods 1) and 2) singly or in combination enables coverage of the entire surface of the scintillator layer 101b with the first protective film 102a, while substantially not being adhered.

The state of the first protective film 102a not being substantially adhered to a planar light-receiving element can be achieved by the following method:

(1) After the scintillator panel 1a is superimposed onto the planar light-receiving element, optimum pressure is applied from the second protective film side by employing elasticity of a foamed material such as a sponge. The foregoing (1) can result in a state that the first protective film 102a is not substantially adhered to the planar light-receiving element.

Taking into account formability of an air gaps, protection of the scintillator layer, sharpness, moisture proofing, workability and the like, the thickness of a protective film is preferably not less than 12 μm and not more than 200 μm, and more preferably not less than 20 μm and not more than 40 μm. The thickness indicates an average value obtained by measurement of ten portions by using a contact type film thickness meter (PG-01), produced by Techlock Co.

Taking into account sharpness, radiographic image uniformity, production stability and workability, the haze ratio is preferably not less than 3% and not more than 40%, and more preferably not less than 31 and not more than 10%. The haze ratio is a value measured by NDH 5000W, produced by Nippon Denshoku Kogyo Cp., Ltd.

Taking into account photoelectric conversion efficiency and emission wavelength of the scintillator, the light transmittance of a protective film is preferably not less than 70% at 550 nm, but since a film of light transmittance of more than 99% is not industrially available, 99% to 70% is substantially preferred. The light transmittance is a value determined by a spectrophotometer (U-1800, produced by Hitachi High-Technologies Inc.).

Taking into account protection and deliquescence of the scintillator layer, the moisture permeability of a protective film is preferably not more than 50 g/m²·day (40° C.·90% RH) and more preferably not more than 10 g/m²·day (40° C.·90% RH), which is determined in accordance with JIS 20208.

As shown in the drawing, sealing the scintillator plate 101 with the first protective film 102a and the second protective film 102b may be performed by any known method. To perform effective sealing via heat welding by using an impulse sealer, for example, it is preferred to use a thermally fusible resin film for the protective film 102a and the innermost layer in contact with the protective film 102b.

FIG. 4 illustrate the state of light refraction within the air gap 108 shown in FIG. 3 and the state of light refraction when a conventional protective film is in close contact with a scintillator layer. FIG. 4(a) illustrates light refraction in the air gap 108, as shown in FIG. 3. FIG. 4(b) illustrates light refraction in the state when a conventional protective film is in close contact with a scintillator layer.

First, there will be described the case of FIG. 4(a).

As shown in this figure, a air gap 108 (air space) is present between a protective film and a scintillator layer the refractive index of a first protective film 102a and that of the air gap 108 (airspace) satisfy the relationship:

refractive index of a first protective film>>refractive index of the air gap (airspace).

Accordingly, lights R-T emitted on the surface of the scintillator layer enter the inside of the protective film without being reflected on the interface between the first protective film 102a and the air gap (airspace) 108 (in a state having no critical angle). The thus entered light is externally emitted through an optical contrast structure of airspace (low refractive layer)/protective film/airspace without being reflected again in the interface between the protective film and the airgap, rendering it feasible to prevent deterioration of image sharpness.

Next, there will be described the case of FIG. 3(b).

In the case shown in the figure, since a protective film and a scintillator layer are in contact with each other, of lights X-Z emitted from the phosphor surface, light Z of an angle exceeding the critical angle θ exhibits an increased ratio of being totally reflected at the interface through an optical contrast structure of protective layer/airspace, which has been shown to be one of causes for deteriorated image sharpness.

In the present invention, when a scintillator plate is sealed with a first protective film and a second protective film, as shown in FIG. 3(a), a scintillator layer and the first protective film are placed substantially without being adhered therebetween, and a protective layer and a planar light-receiving element are also placed substantially without being adhered therebetween, which renders it feasible to produce a scintillator plate without deteriorating sharpness.

It was further proved that a 50-500 μm thick polymer film substrate and a total scintillator panel thickness of not more than 1 mm render it feasible to change the form of the scintillator panel to fit the shape of the planar light-receiving element, permitting uniform sharpness over the entire light-receiving surface of a flat panel detector, whereby the present invention has come into being.

In the present invention, as shown in FIGS. 1-3, when a scintillator plate was sealed with a first protective film and a second protective film, the first protective film covering the scintillator layer was placed substantially without being adhered, that is, contact points are provided between the scintillator layer and the first protective film, forming air gaps (airspaces) between the contact points, whereby the following advantageous effects were achieved.

(1) The use of films of polypropylene, polyethylene terephthalate, polyethylene naphthalate and the like, which were previously difficult for use as a protective film since essential film strength was superior as a physical property for the protective film but a high refractive index resulted in a lowering of sharpness, has now become easy, rendering it feasible to produce a scintillator panel of enhanced quality and inhibited lowering of performance over a long duration.

(2) The use of a protective film of enhanced resistance to flawing has become feasible, and realizing a scintillator panel of superior durability over a long duration.

(3) There has become realizable a protective layer exhibiting enhanced durability without inhibiting the light guide effect of a phosphor crystal.

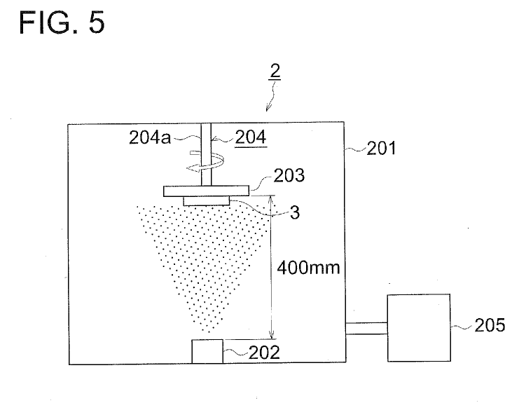

FIG. 5 illustrates a vapor deposition apparatus to form a scintillator layer by a process of vapor deposition.

In FIG. 5, numeral 2 designates an evaporation apparatus. The evaporation apparatus is provided with a vacuum vessel 201, an evaporation source 202 which is installed within the vacuum vessel and deposits vapor onto a substrate 3, a substrate holder 203 to hold the substrate 3, a substrate rotation mechanism 204 to deposit the vapor evaporated from the evaporation source 202 onto the substrate with rotating the substrate holder 203 and a vacuum pump to perform evacuation within the vacuum vessel 201 and introduction of atmosphere.

The evaporation source 202, which houses a scintillator layer forming material and performs heating via resistance heating, may be constituted of an aluminum crucible rounded by a heated, a boat or a heater composed of a high-melting metal. Techniques for heating the scintillator layer forming material include ion beam heating and high-frequency induction heating as well as electrical resistance heating, but resistance heating is preferred in terms of relatively simple constitution, low price and applicability to various materials. The evaporation source 202 may be a molecular beam source employing a molecular beam epitaxial technique.

The substrate rotation mechanism 204 is constituted of, for example, a rotation shaft 204a to rotate the substrate holder 204 with supporting the substrate holder 203 and a motor (which is not designated in this drawing) disposed outside the vacuum vessel 201 and serving as a driving source.

The substrate holder 203 is preferably provided with a heater (not designated in this drawing) to heat the substrate 3. Heating of the substrate 3 performs release/removal of adsorbates on the surface of the substrate 3, preventing generation of an impurity layer between the surface of the substrate 3 and a scintillator layer forming material, enhancing closer contact and controlling quality of the scintillator layer.

Further, there may be provided a shutter (not designated in this drawing) to cutoff the space from the evaporation source 202 to the substrate 3. Non-objective materials adhered onto the surface of a scintillator layer forming material are evaporated through the shutter at the initial stage of evaporation, preventing deposition onto the substrate 3.

To form a scintillator layer on the substrate 3 by using the evaporation apparatus 2, first, the substrate 3 is fitted onto the substrate holder 203, then, the interior of the vacuum vessel is evacuated. Thereafter, the substrate holder is rotated toward the evaporation source 202 through the substrate rotation mechanism 204. When the vacuum vessel 201 reaches a degree of vacuum capable of performing vapor deposition, a scintillator layer forming material is evaporated from the heated evaporation source 202 to allow a phosphor to grow to an intended thickness on the surface of the substrate 3. In that case, the distance between the substrate 3 and the evaporation source 202 is preferably from 100 to 1500 mm. The scintillator layer forming material to be used as an evaporation source may be fabricated in tablet form by pressure compression or may be in the form of powder. In place of a scintillator layer forming material, there may be used its raw material or a mixture thereof.

### Radiation Flat Panel Detector

A radiation flat panel detector related to the present invention is capable of digitizing image data by converting emission from a scintillator panel to electric charges on the surface of a planar light-receiving element.

In a direct deposition type (integral type), deposition is performed directly onto the surface of a planar light-receiving element to form an integrated scintillator formed of a planar light-receiving element and a scintillator layer. On the contrary, an indirect deposition type (separated independent type) of the present invention is constituted of a scintillator panel placed on the surface of a planar light-receiving element, which is featured in that the scintillator panel is not physicochemically adhered to the surface of the flat light-receiving element.

### EXAMPLES

The present invention will be described with reference to examples but is not limited to these.

### Example 1

### Preparation of Scintillator Plate

### Substrate:

A 0.125 mm thick polyimide film (90 mm×90 mm) was prepared as a substrate.

### Formation of Reflection Layer

A 0.2 μm (2000 Å) thick reflection layer was formed by sputtering aluminum onto the one side of the polyimide substrate.

### Formation of Subbing Layer

### Resin Subbing Layer A:

| | |
|---|---|
| Biron 630 (polyester resin, | 100 parts by mass |
| Produced by TOYOBO CO., Ltd.) | |
| Methyl ethyl ketone (MEK) | 100 parts by mass |
| Toluene | 100 parts by mass |

The foregoing components were mixed and dispersed by a beads mill for 15 hrs. to obtain a coating solution for subbing. The obtained coating solution was coated on the foregoing substrate by a bar coater and dried at 100° C. for 8 hrs to form a dry thickness of 1.0 μm, whereby a subbing layer was prepared.

### Formation of Scintillator Layer

Using an evaporation apparatus, as shown in FIG. 5, a phosphor (CsI:0.003 Tl) was deposited on the prepared substrate to form a scintillator layer, whereby a scintillator plate was obtained.

Specifically, a raw material of a phosphor (CsI:0.003 Tl) was placed into a resistance-heating crucible, a substrate was placed on a substrate holder and the distance between the resistance-heating crucible and the substrate was adjusted to 400 mm. Subsequently, the interior of the evacuation apparatus was evacuated and after controlling a degree of vacuum to 0.5 Pa with introducing Ar gas, the temperature of the substrate was held at 140° C., while rotating the substrate. Subsequently, the resistance-heating crucible was heated to evaporate the phosphor and evaporation was completed when a scintillator layer reached a thickness of 600 μm, whereby a scintillator was obtained.

### Annealing of Scintillator Plate

The obtained scintillator plate was subjected to annealing in an inert oven under a nitrogen atmosphere at 250° C. over 3 hrs.

The annealed scintillator plate was treated to prepare a scintillator plate.

### Preparation of Protective Film

There were prepared the first protective film and the second protective films, as shown in Table 1.

TABLE 1

| | Constitution |
|---|---|
| Constitution (A) | PET (12 μm)//CPP (30 μμ) |
| Constitution (B) | Alumina-deposited (50 nm) PET (12 μm)*¹// |
| | CPP (30 μm) |
| Constitution (C) | Blue-colored, matted PET (12 μm)*²//Alumina- |
| | deposited (25 nm) PET (12 μm)*³//CPP (30 μm) |
| Constitution (D) | PET (100 μm)//Aluminum foil//CPP (40 μm) |

*¹Alumina-deposited surface being on the “//” side
*²Outermost surface of one side being matted, blue-colored surface being on the “//” side and exhibiting a blue density to lower a transmittance at 550 nm by 5%
*³alumina-deposited surface being on the side of blue-colored, matted PET

In Table 1, designation “//” indicates a adhesion layer by dry lamination.

The adhesion layer was comprised of a polyol/isocyanate urethane) adhesive and laminated by a dry lamination method.

### Preparation of Scintillator Panel

The thus prepared scintillator plate was sealed by a protective film shown above and was sealed in the form shown in FIG. 1(c) to prepare a scintillator panel.

Sealing was performed by conducting thermal welding under a reduced pressure of 1000 Pa so that a protective layer had a lug at a length shown in Tables 2 and 3. An impulse sealer used for welding employed a 1, 2 or 4 mm wide heater.

TABLE 2

| | Constitution | Constitution | MP*¹ of | MP/μm of Heat- | MP/μm of Blue- |
|---|---|---|---|---|---|
| | of First | of Second | Moisture-Proof | Fusible Layer | colored PET |
| | Protective Film | Protective Film | Layer (g/m² · 24 h) | CPP (g/m² · 24 h · μm) | (g/m² · 24 h · μm) |
| Example 1 | (B) | (B) | 0.075 | 300 | — |
| Example 2 | (B) | (B) | 0.075 | 300 | — |
| Example 3 | (C) | (D) | 0.15 | 300 | 600 |
| Comparison 1 | (A) | (A) | — | 300 | — |
| Comparison 2 | (B) | (B) | 0.075 | 300 | — |
| Comparison 3 | (C) | (D) | 0.15 | 300 | 600 |

*¹MP: Moisture permeability (or water vapor transmission rate), determined in accordance with JIS Z 0208

TABLE 3

| | | | Lug | Lug | Lug |
|---|---|---|---|---|---|
| | First | Second | Length of | Length | Length |
| | Protective | Protective | Protective | (A-1) *¹ | (A-2) *² |
| | Film | Film | Layer (mm) | (mm) | (mm) |
| Example 1 | (B) | (B) | 2 | 2 | 4 |
| Example 2 | (B) | (B) | 4 | 2 | 4 |
| Example 3 | (C) | (D) | 4 | 2 | 4 |
| Comparison 1 | (A) | (A) | 1 | *³ | *³ |
| Comparison 2 | (B) | (B) | 1 | 2 | 4 |
| Comparison 3 | (C) | (D) | 1 | 2 | 4 |

*¹ Lug length meeting expression (A-1)
*² Lug length meeting expression (A-2)
*³ Having no moisture-proof layer

### Measurement of Emission Luminance

Samples were each set to a 10 cm×10 cm CMOS flat panel (X-ray CMOS camera system Shadow-Box 4KEV, produced by Rad-icon Imaging Corp.) and the backside of each sample (i.e., the side having no phosphor scintillator layer) was exposed to X-rays at a tube voltage of 80 kVp. A measured value of instantaneous emission was defined as luminance (sensitivity). Luminance was represented by a relative value, based on the luminance of a scintillator panel of Comparison being 1.00.

### Moisture-Proof Test

Samples were incubated over seven days in a humidifying cycle, such as being heated at 20° C. for 5.5 hrs., followed by the temperature being raised for 0.5 hr., followed by being heated at 30° C. and 80% RH for 5 hrs., followed by the temperature being lowered for 1 hr. and followed by being heated at 20° C., whereby there was determined the deterioration rate of sharpness (MTF), as defined below. The evaluation method of sharpness will be described later.

Deterioration rate of sharpness={1−[(sharpness after being incubated)/(initial sharpness]}×100%

Samples were evaluated based on the deterioration rate of sharpness, as below:

A: not less than 0% and less than 5%,

B: not less than 5% and less than 20%.

C: not less than 20% and less than 30%,

D: not less than 30%.

### Specific Defect Generation Ratio on Moisture-Proof Test

The above moisture resistance test was conducted for 1,000 samples, and a specific defect generation ratio was calculated as follows.

“Specific defect generation”, as described herein, refers to an evaluation sample, which was lower by two ranks from the average value when evaluated at four ranks A, B, C, and D.

Further, the generated ratio of specific problem generated sample is represented by a specific problem generated ratio (Formula 1).

Specific problem generated ratio=(number of specific problem generated sample sheets/1,000 evaluated samples)×100% (Formula 1)

Based on the above specific trouble generated ratio, the following evaluation was made.

A: 0%

B: more than 0% and less than 5%

C: not less than 5% and less than 20%

D: not less than 20%

### Evaluation of Sharpness

Each sample was mounted on 10 cm long×10 cm wide CMOS flat-panel (X-ray CMOS camera system SHAD-O-BOX 4KEV, produced by Rad-ikon Co.), and MTF of each sample was determined and calculated based on 12 bit output data.

In practice, X-rays at a tube voltage 80 kVp were exposed onto the rear side (the side on which no phosphor layer was formed) of each sample through a lead MTF chart, and image data were detected by the CMOS flat-panel and recorded onto a hard disk. Thereafter, the data recorded on the hard disk was analyzed via a computer, and the modulation transfer function (MTF) of the X-ray image recorded on the foregoing hard disk was calculated. There were thus obtained resulting calculation results (MTF values in % of a spatial frequency of 1 cycle/mm). The higher is the MTF value, the better the sharpness becomes.

### Image Uniformity and Linear Noise

Each sample was mounted on 10 cm×10 cm CMOS flat-panel (X-ray CMOS camera system SHAD-O-BOX 4KEV, produced by Rad-ikon Co.), and α-rays at a tube voltage of 80 kVp were exposed onto the rear side (the side on which no scintillator phosphor layer was formed), whereby a solid image was captured. The resulting printed image was visually observed, and generation of image non-uniformity and linear noise was evaluated. The image uniformity and linear noise were evaluated as follows.
A: neither image non-uniformity nor linear noise was noted
B: slight image non-uniformity and linear noise were noted at 1 or 2 positions on the surface
C: slight image non-uniformity and liner noise were noted at 2-4 positions of the surface
D: image non-uniformity and linear noise were noted at least 4 positions and dark areas were noted at fewer then 5 positions

The above evaluation results are summarized in Table 4.

TABLE 4

| | | | Specific | Image |
|---|---|---|---|---|
| | | Moisture | Defect | Uniformity |
| | Emission | Proof | Generation | and Linear |
| | Luminance | Test | Ratio*¹ | Noise |
| Example 1 | 1.00 | A | B | A |
| Example 2 | 1.00 | A | A | A |
| Example 3 | 0.95 | A | A | A |
| Comparison 1 | 1.00 | D | D | D |
| Comparison 2 | 1.00 | C | D | C |
| Comparison 3 | 1.00 | C | D | C |

*¹Specific defect generation ratio on moisture proof test

As is apparent from the results shown in Table 4, it was proved that, in Examples related to the present invention, deterioration rate of sharpness and specific defect generation Ratio on moisture-proof test were lowered, and image non-uniformity and linear noise were markedly reduced.

1. A scintillator panel comprising a scintillator plate comprising on a substrate a reflection layer, a subbing layer and a scintillator layer, wherein the scintillator plate comprises a protective layer comprising a first protective film provided on a side of the scintillator layer and a second protective film provided on a side of the substrate opposite the scintillator layer and the protective layer has a lug which is a portion sealed with the first protective film and the second protective film, and wherein a length of the lug of the protective layer is represented by the following expression (A-1), the first protective film is not adhered to the scintillator layer and the scintillator plate is provided as a constituent element for a radiation flat panel detector without being physicochemically adhered to a surface of a planar light receiving element,
Expression (A-1):
provided that a layer existing between moisture-proof layers of the first protective film and the second protective film and exhibiting a highest moisture permeability has a thickness exhibiting a moisture permeability equivalent to a moisture permeability in a direction of thickness of a moisture-proof layer of the first protective film or a moisture permeability of two times the moisture permeability in a direction of thickness of a moisture-proof layer of the first protective film,
a length of the lug of the protective layer=at least a length in a direction of length of the lug, which is a difference in thickness between a layer exhibiting a moisture permeability equivalent to a moisture permeability of a moisture-proof layer of the first protective film and a layer exhibiting a moisture permeability of two times the moisture permeability of a moisture-proof layer of the first protective film.

2. The scintillator panel as claimed in claim 1, wherein the length of the lug of the protective layer is represented by the following expression (A-2),
Expression (A-2):
provided that a layer existing between moisture-proof layers of the first protective film and the second protective film and exhibiting a highest moisture permeability has a thickness exhibiting a moisture permeability equivalent to a moisture permeability in a direction of thickness of a moisture-proof layer of the first protective film,
a length of the lug of the protective layer=at least a length in a direction of length of the lug and equivalent to a thickness of the layer exhibiting a moisture permeability equivalent to a moisture permeability of a moisture-proof layer of the first protective film.

3. The scintillator panel as claimed in claim 1, wherein the scintillator layer is a columnar phosphor layer which is comprised of cesium iodide and is formed by a process of vapor deposition.

4. The scintillator panel as claimed in claim 1, wherein the substrate is a heat-resistant resin.

5. A radiation flat panel detector comprising a scintillator panel as claimed in claim 1, wherein the scintillator panel is not physicochemically adhered to a surface of a planar light receiving element.
